(19) United States
(12) Patent Application Publication
(10) Pub. No.: US 2012/0001393 A1
(43) Pub. Date: Jan. 5, 2012

(54) DEFORMABLE COMPOSITE PLUG

(75) Inventors: Richard J. Lazzara, Palm Beach Gardens, FL (US); Christopher J. Lazzara, Palm Beach Shores, FL (US); Tammy M. Bomia, Lake Worth, FL (US); James R. Schwarz, West Palm Beach, FL (US)

(73) Assignee: Neptune Research, Inc., Lake Park, FL (US)

(21) Appl. No.: 13/164,195

(22) Filed: Jun. 20, 2011

Related U.S. Application Data
(60) Provisional application No. 61/361,150, filed on Jul. 2, 2010.

(51) Int. Cl. F16J 15/02

(52) U.S. Cl. 277/316; 277/590

(57) ABSTRACT

Deformable plugs, fluid seals formed from a deformable plug, and methods for sealing a hole with a deformable plug, are provided herein. In some embodiments, the deformable plug includes a resinous composite that expands and solidifies upon exposure to a catalyst. A carrier with a compressible body configured to embed within a hole is impregnated with the resinous composite. The fluid seal can be formed from a carrier with a porous body that is compressively embedded within a hole. The carrier is impregnated with a resinous composite that expands and solidifies upon exposure to a catalyst. One or more anchors are formed from the resinous composite after being exposed to the catalyst. The anchors retain the carrier inside the hole.

### CROSS-REFERENCE AND CLAIM OF PRIORITY TO RELATED APPLICATION

This application claims the benefit of and priority to U.S. Provisional Patent Application No. 61/361,150, filed Jul. 2, 2010, which is incorporated herein by reference in its entirety.

### TECHNICAL FIELD

The present disclosure relates generally to plugs and stops, and more particularly to plugs formed from deformable materials for filling openings of assorted shapes and sizes.

### BACKGROUND

When an opening occurs in a container, barrel, vessel, tank, or other structure, whether accidentally or intentionally, liquid can rapidly leak out from or into the opening. In the instance of a fluid container or tank, this typically results in a loss of material, which can be costly and, in some scenarios, can contaminate the surrounding area. In the case of a vessel or hull, entering water can damage the vessel and potentially cause sinking of the vessel.

Unintentional openings, such as those caused by corrosion or collision, are often irregular in shape and size. One existing method used to plug an irregular opening is to drive a wooden peg or wedge into the opening. The problem with this method is that the irregular shape of the opening leaves gaps between the peg and opening, creating leakage pathways through which liquid can flow. Another problem associated with these inserts is that the peg or wedge must be forced into the irregular opening, for example, by tapping, squeezing, or hammering. The force at which the peg is mechanically forced into the opening and the degree of bite or grip of the peg material determines the relative pressure, force, or resistance that the insert is capable of holding or withstanding.

As the exact shape and size of an unintentional puncture or hole is relatively unpredictable, current remedial measures for addressing such opening requires a wide variety of plug shapes and sizes be inventoried in anticipation of such unintended openings. In addition, other tools are often required for application purposes, such as a hammer or mallet, which is needed to drive the above-mentioned pegs into the opening.

### SUMMARY

According to aspects of the present disclosure, a deformable plug for sealing an aperture or hole is provided. In this embodiment, the deformable plug includes a resinous composite that is configured to expand and solidify upon exposure to a catalyst. The deformable plug also includes a carrier with a compressible body that is configured to embed within the aperture. The carrier is impregnated with the resinous composite.

According to other aspects of the present disclosure, a fluid seal fluidly sealing an aperture or hole in a wall is featured. In this embodiment, the fluid seal includes a carrier with a porous body that is compressively embedded within the aperture. The carrier is impregnated with a resinous composite that is configured to expand and solidify upon exposure to a catalyst. At least one anchor is formed, at least in part, from the resinous composite after the composite is exposed to the catalyst. The at least one anchor attaches the carrier to the wall.

In accordance with yet another aspect of the present disclosure, a method is presented for sealing an aperture or hole in a wall with a deformable plug. In this embodiment, the method includes pressing the deformable plug into the aperture in the wall, the deformable plug including a carrier with a compressible body, the carrier being impregnated with a resinous composite configured to expand and solidify upon exposure to a catalyst. The carrier is exposed to the catalyst such that the resinous composite expands to create at least one anchor and fills gaps between the carrier body and the aperture. The resinous composite is cured such that the at least one anchor hardens and attaches the deformable plug to the wall.

The above summary is not intended to represent each embodiment, or every aspect, of the present disclosure. Rather, the above features and advantages, and other features and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a perspective-view illustration of a deformable plug in accordance with aspects of the present disclosure;

FIG. 2 is an elevated perspective-view illustration of a seal in accordance with aspects of the present disclosure;

FIG. 3 is a cross-sectional side-view illustration of the seal from FIG. 2;

FIG. 4 is an elevated perspective-view illustration of a deformable plug with a handle in accordance with aspects of the present disclosure;

FIG. 5 is an elevated perspective-view illustration of another deformable plug with a handle in accordance with aspects of the present disclosure;

FIG. 6 is a flow chart diagrammatically illustrating a method for sealing a hole with a deformable plug in accordance with aspects of the present disclosure; and

FIG. 7 is a perspective-view illustration of another deformable plug in accordance with aspects of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE EXEMPLARY EMBODIMENTS

While this invention is susceptible of embodiment in many different forms, there is shown in the drawings and will herein be described in detail representative embodiments of the invention with the understanding that the present disclosure is to be considered as an exemplification of the various aspects and principles of the invention, and is not intended to limit the broad aspect of the invention to the embodiments illustrated.

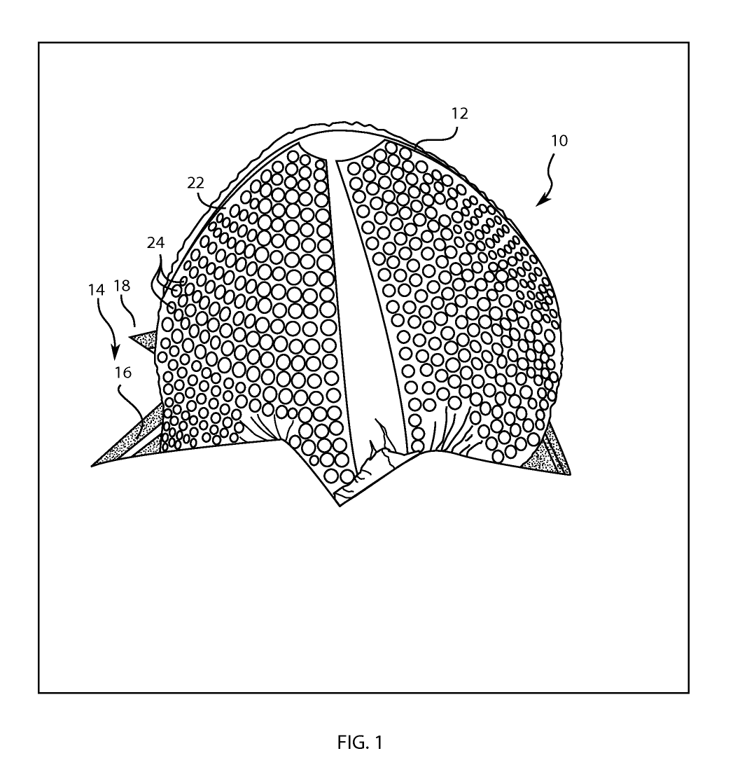

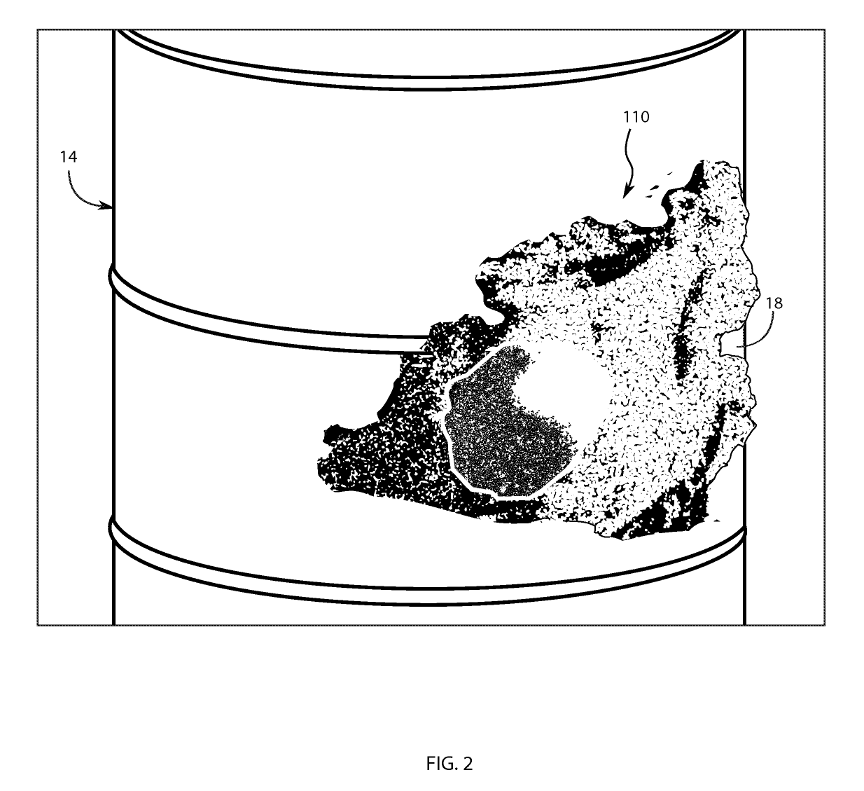

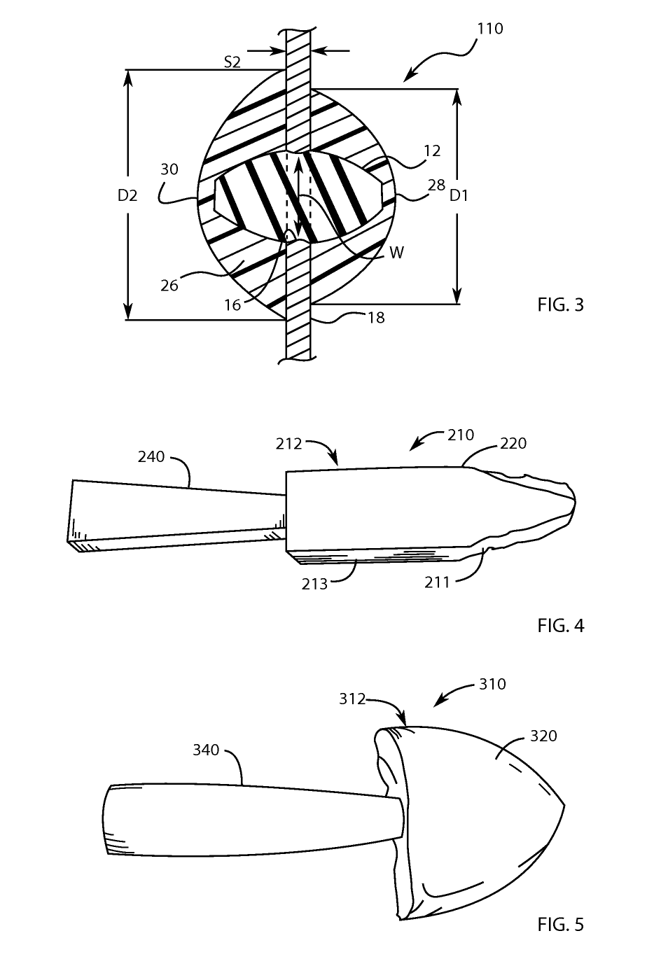

Referring to the drawings, wherein like reference numbers refer to like components throughout the several views, FIGS. 1, 4 and 5 illustrate various deformable plugs, respectively designated at 10, 210 and 310, in accordance with different aspects of the present disclosure. In addition, FIGS. 2 and 3 illustrate a fluid seal 110 in accordance with several aspects of the present disclosure. The illustrations presented in FIGS. 1-5 are provided merely for explanatory purposes, and should therefore not be considered limiting. By way of example, and not limitation, the deformable plug 10 of FIG. 1 and the fluid seal 110 of FIG. 2 are shown stopping up and fluidly sealing a pointed (i.e., star-shaped) hole 16 in a wall 18 of a steel drum 14. However, the concepts of the present disclosure are just as applicable to holes of any shape. Likewise, the plugs and seals presented herein may be employed to occlude and close openings in innumerable structures, such as pipes, boats and personal watercraft, industrial storage containers, fluid tanks, etc. To that end, one of the major advantages of the deformable plugs and fluid seals presented herein is their universal applicability. On a final note, the drawings presented herein are not to scale and are provided purely for instructional purposes. Thus, the individual and relative dimensions shown in the drawings are not to be considered limiting.

The deformable plug 10 of FIG. 1 includes a carrier 12 that is impregnated with the resinous composite, which is not readily visible in FIG. 1 but will be described below with respect to FIGS. 2 and 3. The carrier 12 includes a compressible and porous body that is configured to press-fit into and embed within the hole 16. By way of non-limiting example, the carrier body may be fabricated from natural or synthetic sponge and foam materials, such as wood fiber, polyether, polyester polyurethane, polyvinyl alcohol (PVA), and cellulose based foam and sponge materials, which may be low- to high-density, may have small, medium, large, micro or twin-pore sizes, may be closed- or open-cell, may be flexible or semi-rigid, and may be plain, melamine or post treated, or in any combination of the above options. In some embodiments, the carrier body, or at least a portion thereof, has a durometer rating of at least approximately 30-70 Shore D. In some exemplary embodiments, the resinous composite has a density of approximately 1.11 g/cm³. In some exemplary embodiments, the carrier 12 has a density of approximately 0.02 g/cm³. It is contemplated that in certain embodiments, the durometer rating and densities may be higher or lower than the values described herein.

The carrier 12 is illustrated in FIG. 1 as an ellipsoid (e.g., football-shaped); however, the carrier 12 may take on additional shapes and sizes without departing from the intended scope of the present disclosure. By way of non-limiting example, the carrier may be conical, frusta-conical, polyhedral (see, e.g., FIG. 4), spherical, semi-spherical (see, e.g., FIG. 5), etc. Moreover, the carrier 12, as shown, is approximately 6 inches (15.2 cm) long with a central diameter of approximately 4.5 inches (11.4 cm). However, these dimensions may be selectively modified depending on, for example, the expected size and shape of the hole 16, packaging constraints, cost restrictions, etc. For example, in other exemplary configurations, the carrier 12 may be approximately 6 inches (15.2 cm) long with a central diameter of approximately 3.5 inches (8.9 cm), or may be approximately 9 inches (22.9 cm) long with a central diameter of approximately 4.5 inches (11.4 cm). In other embodiments, the carrier may have a central diameter or short width dimension ranging from approximately 2 to 8 inches (5.1 to 20.3 cm) and a longitudinal or long dimension of approximately 4 to 16 inches (10.2 to 40.6 cm).

The carrier 12 may be provided with a protective outer surface 22. The outer surface 22 may be designed to improve handling and control of the carrier 12 by providing a more ergonomic gripping surface having, for example, an array of raised dimples 24 protruding outwardly from the surface 22. Alternatively, the outer surface 22 may be smooth, but fabricated from a material with tacky characteristics. The outer surface 22 may be further designed to provide a protective barrier that shields the resinous composite from outside contaminants and, conversely, insulates the user from the contents of the carrier 12. The thickness, total surface area and distribution of the outer surface 22 over the carrier body may be selectively varied depending, for example, on the intended use of the deformable plug 10. Although shown in FIG. 1 as only covering a portion of the carrier 12, the outer surface 22 may cover the entire carrier 12. In this example, the outer surface 22 may contain sufficient resinous composite to provide the adhesive and mounting characteristics described below, or may be sufficiently permeable to allow resinous composite to expand through the outer surface 22.

As previously stated, the carrier 12 is impregnated, permeated, infused, coated, or otherwise provided with a resinous composite. In certain embodiments, such as those illustrated in FIGS. 2 and 3, the resinous composite, designated generally as 26 in FIG. 3, is configured to expand and solidify upon exposure to a catalyst. In some embodiments, the resinous composite is a self-adhering, pliable-plastic resin that is configured to begin hardening upon exposure to an aqueous solution (e.g., water). In some applications, such as a leaking vessel, the resinous composite can be activated by the entering water. Alternatively, the user may be required to add an aqueous solution to activate the resinous composite. The resinous composite 26 may comprise, for example, polyol, diisocyanate, titanium dioxide, tinivun, and phosphoric acid. In alternative configurations, the carrier 12 may comprise a resin that is light-cured (e.g., via UV or LED spot curing), heat-cured (i.e., thermoset), or set by mixing one part of the resin with another compound, or any combination thereof. For example, epoxy copolymers may be hardened as a result of mixing an epoxide resin with a polyamine monomer “hardener”. Other alternative makeups, such as expanding compounds and resins, are also envisioned as being within the scope and spirit of the present disclosure.

Turning to FIG. 3, the carrier body is compressively embedded and physically retained within the hole 16. In addition to the expansive characteristics of the carrier body providing a press-fit engagement between the plug 10 and the hole 16, catalyzing and curing the resinous composite 26 acts to securely attach the deformable plug 10 to the wall 18. According to one embodiment, the catalyzed resinous composite 26, once cured, adheres the carrier 12 to the wall 18. Optionally, the expanding resin 26 also acts to inflate the carrier 12 against the inner periphery of the hole 16, increasing the compressive retention therebetween.

In certain embodiments, the catalyzed resinous composite 26 generates one or more anchors, each of which is configured to mechanically hold the plug 10 in the hole 16. The resinous composite 26 is shown in FIG. 3 in an exemplary expanded state, which results from exposure to the catalyst. In the illustrated embodiment, the resinous composite 26, upon exposure to the catalyst, expands into and around the hole 16, filling any gaps between the wall 18 and the outer surface 26 of the carrier 12. It may be desirable, in certain applications (e.g., a flooding boat or a leaking drum of chemical waste) that the catalyzed resinous composite 26 be able to expand against a fluid pressure of up to or greater than approximately 5 pounds per square inch (psi). Moreover, the carrier 12 and resinous composite 26 may be designed such that one of the anchors expands and cures quicker than the other anchor in order to secure the carrier 12 against the flow of fluid while the remainder of the resinous composite 26 expands and cures. The anchor(s) may comprise the carrier 12 being inflated by expanding resin contained therein, by resin expanding outside of the carrier 12, or a combination of both.

Once cured, the resin 26 may create a first anchor 28 of a first size on a first side S1 of the wall 18, and a second anchor 30 of a second size on a second side S2 of the wall 18. Although other configurations are certainly envisioned, the anchors 28, 30 shown are semi-spherical, similar to a mushroom cap. The first anchor 28 lies generally flush against the first side S1 of the wall 18 in opposing, spaced relation to the second anchor 30, which lies generally flush against the second side S2 of the wall 18. The first and second anchors 28, 20 are attached together by the carrier body. As seen in FIG. 3, the first anchor 28 has a first diameter D1 that is greater than the width W of the hole 16. To that regard, the second anchor 30 has a second diameter D2 that is greater than the width W of the hole 16 and the first diameter D1 of the first anchor 28. Although designated as “diameter” and “width,” the dimensions illustrated in FIG. 3 with respect to the anchors 28, 30 and the hole 16 may comprise heights, widths, lengths, etc., depending upon the shape of the respective anchor or hole and the perspective taken thereof.

FIGS. 4 and 5 each illustrate a deformable plug with a handle in accordance with certain embodiments of the present disclosure. In particular, FIG. 4 presents a deformable plug, designated generally as 210, with a handle 240 that projects longitudinally from one end of a carrier 212. The carrier 212 of FIG. 4 has a compressible and porous body 220 comprising a spiked, pyramidal front-end 211 and a polyhedral trailing end 213. Likewise, FIG. 5 presents a deformable plug, designated generally as 310, with a handle 320 that projects longitudinally from one end of a carrier 312. In contrast to the embodiment of FIG. 4, the carrier 312 of FIG. 5 has a dome-shaped compressible and porous body 320. Similar to the carrier 12 of FIG. 1, the carriers 212 and 312 of FIGS. 4 and 5, respectively, are impregnated with the a resinous composite, such as composite 26 of FIG. 3, that is configured to expand and solidify upon exposure to a catalyst, thereby retaining the composite plug 210, 310 within a hole or aperture that is to be sealed. The handles 240, 340 can be designed to provide a base, support, and/or skeleton for the carriers 220, 230, respectively, making application of the deformable plugs 210, 310 easier and more effective because the rigid portion provides mechanical stability during the curing process and prevents the resin 26 from being inadvertently pushed through hole 16. The deformable plugs 210 and 310 of FIGS. 4 and 5, respectively, may include the same features and characteristics described above with respect to the deformable plugs of FIGS. 1-3, in any combination.

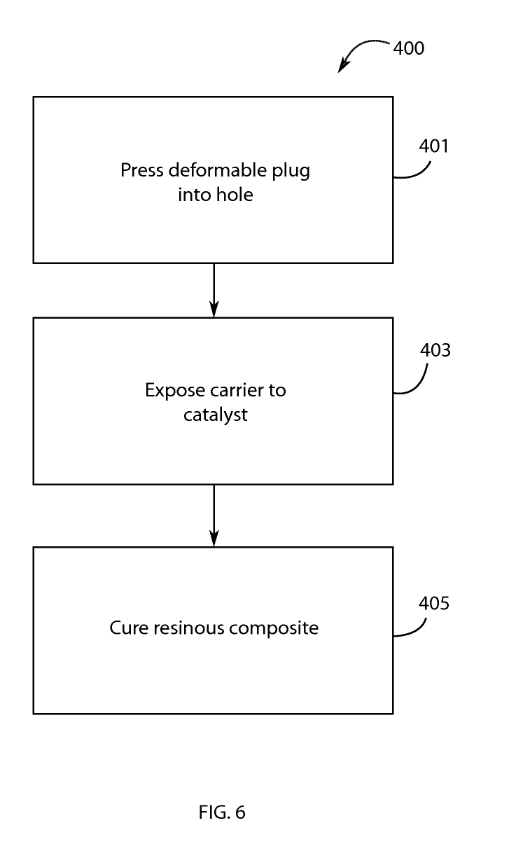

With reference now to the flow chart of FIG. 6, an improved method for sealing a hole in a wall with a deformable plug is generally described at 400 in accordance with certain embodiments. The method or algorithm 400 of FIG. 6 is described herein with respect to the structure illustrated in FIGS. 1-3. However, the claimed methods of the present disclosure are not explicitly limited to the exact configuration of the deformable plug 10 or application of the tank 14 set forth in FIGS. 1-3. Likewise, use of the word “step” or “act” in the specification or claims is not intended to be limiting and should not be considered as limiting.

The method 400 of FIG. 6 includes pressing, drawing, pushing or otherwise placing a deformable plug 10 into a hole 16 in a wall 18, as generally set forth at step 401. The deformable plug 10 includes a carrier 12 with a compressible body. The carrier 12 is impregnated with a resinous composite 26 that is designed to expand and solidify upon exposure to a catalyst, such as water, UV light, heat, or a hardening compound. As the carrier 12 is compressed against the wall 18 (e.g., of a barrel, tank, vessel, etc.), it expands (e.g., flattens) against the surface of the wall, expanding beyond the opening 16, and can fill most/all of the opening 16. Such expansion reduces the leakage of fluid while the catalyst 26 expands and cures.

At step 403, the carrier 20 is exposed to the catalyst such that the resinous composite 26 expands to generate one or more anchors 28, 30 and fill any gaps between the carrier body and the inner periphery of the hole 16. In some embodiments, the resinous composition 26, while curing, will begin to adhere to the wall 18 of the tank 14. At 405, the resinous composite is cured such that the anchors 28, 30 harden and attach the deformable plug 10 to the wall 14. For example, as the catalyzed resin 26 cures and begins to harden, it creates a mushroom-cap like shape on each side S1, S2 of the wall 18, and thereby prevents the carrier 12, once hardened, from being pushed out through the hole 16 (e.g., via differential fluid pressure) and locking the deformable plug 10.

The method 400 may include at least steps 401-405. However, it is within the scope and spirit of the present invention to omit steps, include additional steps, and/or modify the order presented in FIG. 6. For example, in certain embodiments, step 403 may be performed before or contemporaneously with step 401 It should be further noted that the method 400 represents a single sequence to create a single seal. However, it is expected that the method 400 be applied systematically to create more than one seal.

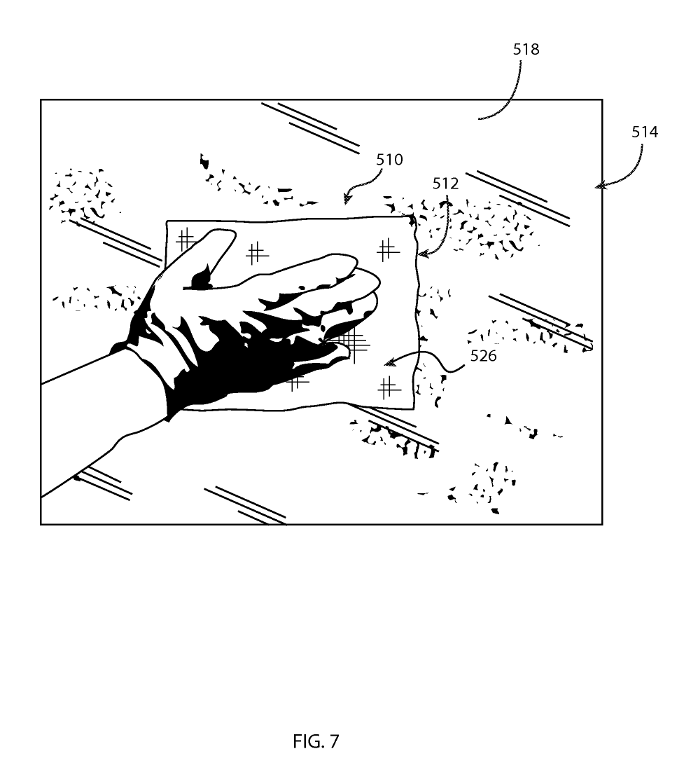

Turning next to FIG. 7, a deformable plug 510 is shown in accordance with another aspect of the present disclosure. Like the deformable plugs 110, 210 and 310 of FIGS. 1, 4 and 5, respectively, the deformable plug 510 of FIG. 7 includes a carrier 512 that is impregnated with a resinous composite, which is designated generally by reference numeral 526. The carrier 512 includes a compressible and porous body. By way of non-limiting example, the carrier body may be a non-woven fiberglass patch. The non-woven composition provides additional structural rigidity, for example, by distributing the fiberglass reinforcement in random directions. Put another way, the glass fibers are dispersed indiscriminately, providing reinforcement in an isotropic fashion. The cloth-like composition of a non-woven fiberglass patch also allows the freedom to cut the carrier body into various dimensions and shapes. In addition, the non-woven fabric also reduces voids and air pockets. The patch may also be reinforced, for example, with woven materials and/or non-fiberglass materials. In certain embodiments, the patch may be fabricated from carbon fibers or other aramid fibers.

The carrier 512 is impregnated, permeated, infused, coated, or otherwise provided with a resinous composite 526. Similar to the embodiments described above with respect to FIGS. 1-3, the resinous composite 526 in FIG. 7 is configured to expand and solidify upon exposure to a catalyst. In some embodiments, the resinous composite is a self-adhering, pliable-plastic polyurethane resin that activates and hardens upon exposure an aqueous solution (e.g., water). In alternative configurations, the carrier 12 may comprise a resin that is light-cured (e.g., via UV or LED spot curing), heat-cured (i.e., thermoset), or set by mixing one part of the resin with another compound, or any combination thereof. For example, epoxy copolymers harden as a result of mixing an epoxide resin with a polyamine monomer “hardener”. Other alternative makeups and resins are also envisioned as being within the scope and spirit of the present disclosure.

As seen in FIG. 7, the carrier 512 is compressed against the outside (or inside) surface 518 of a vessel hull 514 or other structure, covering a puncture or breach therein. In some exemplary embodiments, water leaking into the vessel hull 514 activates the resinous composite 526. Activation of the resinous composite 526 generates a foaming action that acts to force the resinous composite 526 into the hole. The foaming resinous composite 526 fills the hole, which in turn and helps seal off the hole and also provides adhesive attributes that attach the carrier 512 to the vessel hull 514.

Similar to the fluid seal 110 of FIG. 3, the activated resinous composite 526 generates one or more anchors, each of which is configured to mechanically retain the carrier 512 in sealing engagement with the hole 16. For instance, as the resinous composite 526 continues to expand into the hole, it may create a mushroom-cap shaped anchor on a side of the vessel hull 516 opposite the carrier 512. In some exemplary configurations, the resinous composite 526 can cure within 3-5 minutes.

In some embodiments, the carrier 512 is a 4-inch by 6-inch cloth patch, impregnated with a resin content of approximately 2.5 ounces. In some embodiments, the ratio of catalyst to resin is approximately 2 grams of catalyst for approximately 7 ounces of resin. In other embodiments, the carrier 512 is impregnated with a resin content of approximately 3 ounces.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A deformable plug for sealing an aperture defined by a containment structure, the deformable plug comprising:
a resinous composite configured to expand and solidify upon exposure to a catalyst; and
a carrier with a compressible body configured to embed within the aperture, the carrier being impregnated with the resinous composite.

2. The deformable plug of claim 1, wherein at least a portion of the carrier has a durometer rating of at least approximately 30-70 Shore D.

3. The deformable plug of claim 1, wherein the carrier is fabricated, at least in part, from a polyurethane open-cell foam material.

4. The deformable plug of claim 1, wherein the carrier further includes a handle protruding from at least one side of the compressible body.

5. The deformable plug of claim 1, wherein the resinous composite, upon exposure to the catalyst, is configured to expand through the aperture against a fluid pressure of at least approximately 5 psi.

6. The deformable plug of claim 1, wherein the resinous composite is a resinous pliable-plastic material hardened by exposure to an aqueous solution.

7. The deformable plug of claim 1, wherein the resinous composite comprises polyol, diisocyanate, titanium dioxide, tinivun, and phosphoric acid.

8. The deformable plug of claim 1, wherein the resinous composite, upon exposure to the catalyst, expands to create at least one anchor configured to retain the plug in the aperture.

9. The deformable plug of claim 1, wherein the aperture is defined through a wall, the resinous composite, upon exposure to the catalyst, creating a first anchor of a first size on a first side of the wall, and a second anchor of a second size on a second side of the wall.

10. The deformable plug of claim 1, wherein the resinous composite, upon exposure to the catalyst, fills a plurality of gaps between the carrier body and the aperture.

11. The deformable plug of claim 1, wherein the aperture is defined through a wall, the resinous composite, upon exposure to the catalyst, adhering the carrier to the wall.

12. A fluid seal fluidly sealing an aperture in a wall, the fluid seal comprising:
a carrier with a porous body compressively embedded within the aperture, the carrier being impregnated with a resinous composite configured to expand and solidify upon exposure to a catalyst; and
at least one anchor formed at least in part from the resinous composite after being exposed to the catalyst, the at least one anchor attaching the carrier to the wall.

13. The fluid seal of claim 12, wherein the at least one anchor comprises a first anchor on a first side of the wall, and a second anchor on a second side of the wall, the carrier body connecting the first anchor to the second anchor.

14. The fluid seal of claim 13, wherein the aperture has a width, the first anchor has a first diameter greater than the width of the aperture, and the second anchor has a second diameter greater than the first diameter of the first anchor and the width of the aperture.

15. The fluid seal of claim 12, wherein at least a portion of the carrier has a durometer rating of at least approximately 30-70 Shore D.

16. A method for sealing an aperture in a wall with a deformable plug, the method comprising:
pressing the deformable plug into the aperture in the wall, the deformable plug including a carrier with a compressible body, the carrier being impregnated with a resinous composite configured to expand and solidify upon exposure to a catalyst;
exposing the carrier to the catalyst such that the resinous composite expands to create at least one anchor and fill gaps between the carrier body and the aperture; and
curing the resinous composite such that the at least one anchor hardens and attaches the deformable plug to the wall.
